(19) United States
(12) Patent Application Publication
(10) Pub. No.: US 2021/0366270 A1
(43) Pub. Date: Nov. 25, 2021

(54) LEARNED QUIET TIMES FOR DIGITAL ASSISTANTS

(71) Applicant: Hewlett-Packard Development Company, L.P., Spring, TX (US)

(72) Inventor: David H. Hanes, Fort Collins, CO (US)

(73) Assignee: Hewlett-Packard Development Company, L.P., Spring, TX (US)

(21) Appl. No.: 16/650,091

(22) PCT Filed: Jan. 18, 2018
(86) PCT No.: PCT/US2018/014216

§ 371 Date: Mar. 24, 2020

(51) Int. Cl. G08C 17/02; G06F 3/16; G10L 15/22; G06N 20/00

(52) U.S. Cl. CPC G08C 17/02; G06F 3/167; G08C 2201/31; G06N 20/00; G10L 15/22

(57) ABSTRACT

In example implementations, a method is provided. The method monitors, by a processor of a voice activated device that is executing a digital assistant, an operation of a secondary device in communication with the voice activated device. A quiet time period is learned based on the operation of the secondary device that is monitored. A quiet time mode is enabled for the quiet time period that is learned. A notification that is received is suppressed when the quiet time mode is enabled.

### BACKGROUND

Electronic devices are used to improve productivity and help improve the lives of individuals. For example, electronic devices can provide messaging, phone calls, electronic mail, provide notifications, control other devices, and the like. These electronic devices can be used at all times of the day and around the clock.

Some electronic devices can provide functionality using voice activation. For example, a user may speak to the electronic device to perform a certain action without pressing a button or selecting options in a graphical user interface. The user may instruct the electronic device to “email recipient” and then speak the content of the email. The electronic device can then generate and send the email with the desired content to the recipient. Voice activation can be used to perform a variety of different functions on the electronic device such as set reminders, send text messages, make a phone call, and the like.

### BRIEF DESCRIPTION OF THE DRAWINGS

FIG. 1 is a block diagram of an example of a network of a voice activated device with a digital assistant and secondary devices of the present disclosure;

FIG. 2 is a more detailed block diagram of an example of the voice activated device of the present disclosure;

FIG. 3 is a flow chart of an example method for learning a quiet time period to enable a quiet time mode; and

FIG. 4 is a block diagram of an example non-transitory computer readable storage medium storing instructions executed by a processor.

### DETAILED DESCRIPTION

Examples described herein provide a method and apparatus for enabling quiet time for digital assistants. As discussed above, the same functionality that helps electronic devices help improve productivity can also hinder productivity. Some electronic devices include a graphical user interface that allows a user to step through a series of menus to set a do not disturb time period.

Currently, a new wave of voice activated devices is being developed. The voice activated devices may operate using a voice activated digital assistant. The voice activated devices may not include a graphical user interface that can be used to set do not disturb hours or quiet times. Thus, voice activated devices with digital assistants may provide light notifications and audio notifications continuously without interruption. The light notifications and audio notifications can become a distraction when trying to focus on another task, wake up an individual in the middle of the night, and the like.

Examples herein provide a way for digital assistants to learn quiet times of a user and automatically enable the quiet time. For example, the digital assistant may collect data from other devices and monitor patterns of behavior of the user. The digital assistant can learn quiet times for the user based on the patterns of behavior.

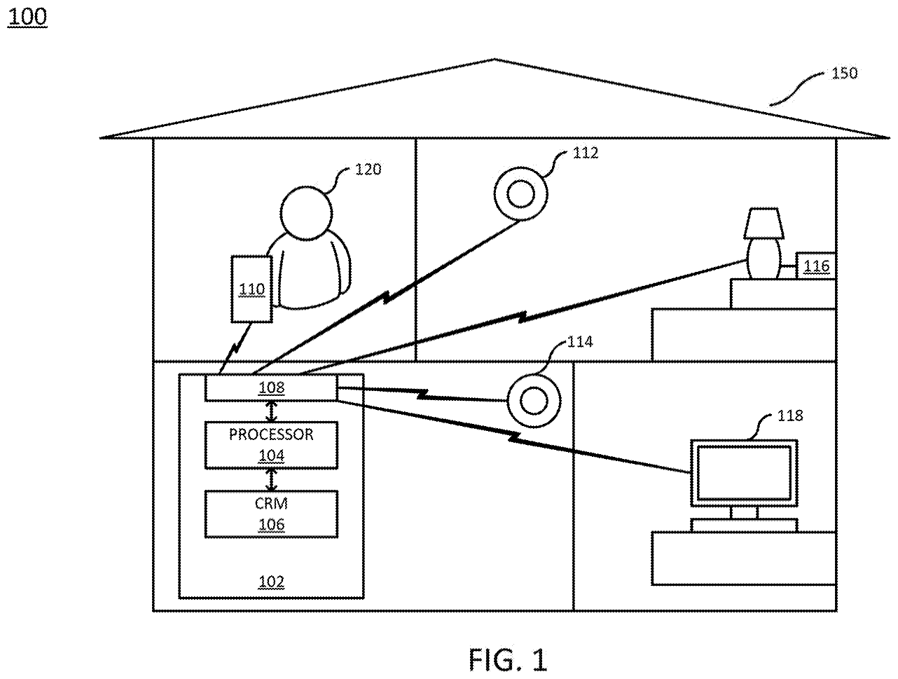

FIG. 1 illustrates an example network 100 of the present disclosure. The network 100 may be deployed at a location 150. The location 150 may be a home, an office building, and the like.

In one example, the network 100 may include a voice activated device 102 and a plurality of secondary devices 110, 112, 114, 116, and 118. The voice activated device 102 may include a processor 104, a computer readable medium 106, and a wireless interface 108. The processor 104 may be communicatively coupled to the computer readable medium 106 and the wireless interface 108.

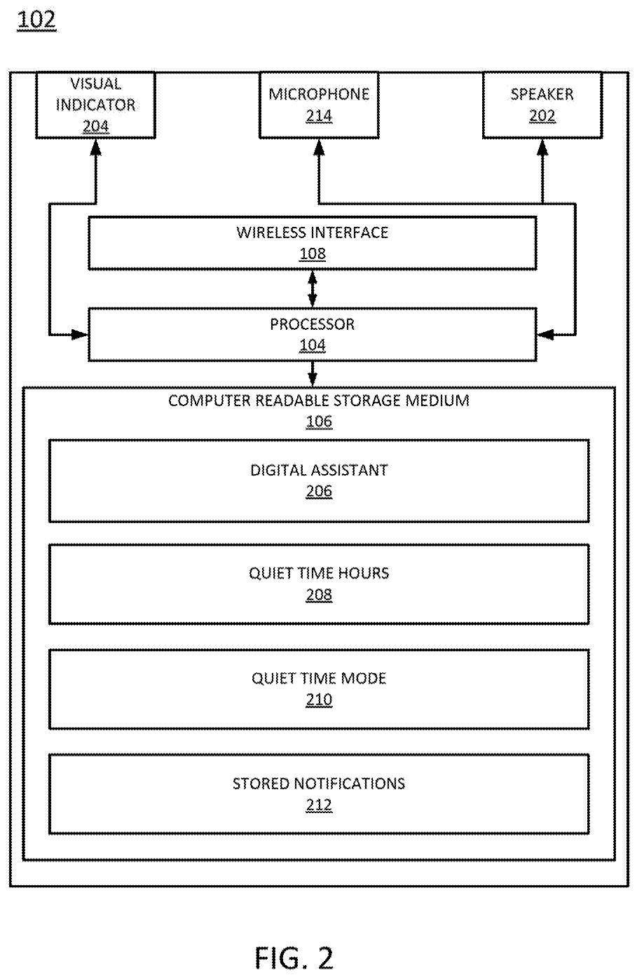

FIG. 2 illustrates a more detailed block diagram of voice activated device 102. FIG. 2 illustrates the processor 104, the computer readable medium 106, and the wireless interface 108 that was illustrated in FIG. 1. In one example, the computer readable medium 106 may be a non-transitory computer readable storage medium such as a hard disk drive, a random access memory (RAM), a read-only memory (ROM), and the like. The computer readable medium 106 may include more than one type of computer readable medium. For example one type of computer readable medium 106 may store data and applications, while another type of computer readable medium 106 may store operating system instructions.

In one example, the computer readable medium 106 may store instructions that can be executed by the processor 104 to perform operations or store other types of data. In one example, the computer readable medium 106 may include a digital assistant 206, quiet time hours 208, a quiet time mode 210, and stored notifications 212.

In one example, the digital assistant 206 may provide a mode of interaction for a user. For example, the digital assistant 206 may receive voice input via a microphone 214 and provide audible feedback via a speaker 202. In one example, the digital assistant 206 may also provide visual indications or feedback via a visual indicator 204. The visual indicator 204 may be a light. For example, the light may be a light emitting diode (LED) that can be animated around a surface of the voice activated device 102, flash on and off, stay on, change colors, and the like.

Notably, the voice activated device 102 does not have a graphical user interface. In other words, the voice activated device 102 does not have any external input/output devices such as a mouse or a display to allow a user to make menu selections with the mouse, and so forth. The main mode of user interaction is via voice commands received by the microphone 214 and audio feedback provided by the speaker 202 or visual feedback provided by the visual indicator 204.

In one example, the quiet time hours may be information that is stored based on a learned pattern of behavior of a user. Referring back to FIG. 1, the digital assistant 206 may monitor the secondary devices 110, 112, 114, 116, and 118 to learn a pattern of behavior. Based on the pattern of behavior, the digital assistant 206 may automatically learn quiet time hours 208 of a user 120. Based on the quiet time hours 208, the digital assistant 206 may automatically enable or disable the quiet time mode 210 stored in the computer readable medium 106.

In one example, the secondary devices 110, 112, 114, 116, and 118 may each transmit data to the voice activated device 102 via a wireless communication. For example, the wireless interface 108 may establish a wireless communication path or wireless connection to each one of the secondary devices 110, 112, 114, 116, and 118 to transmit and receive data. [owls] The secondary devices 110, 112, 114, 116, and 118 may be any type of smart device that can wirelessly communicate with the voice activated device 102. In one example, the secondary device 110 may be an activity tracker or a sleep tracker. For example, the secondary device 110 may detect when the user 120 is moving, when the user 120 is sleeping, and so forth.

In one example, based on the information collected from the secondary device 110, the digital assistant 206 may learn that the user 120 sleeps around 8:30 PM and wakes up at 5:00 AM Sunday through Thursday. The digital assistant 206 may learn that the user 120 sleeps around 11:00 PM on Friday night and wakes up around 9:00 AM on Saturday morning. The digital assistant 206 may also learn that the user 120 goes to sleep around 10:00 PM on Saturday night and wakes up around 7:00 AM on Sunday morning.

As a result, based on the learned pattern of behavior (e.g., a sleeping pattern), the digital assistant 206 may learn that the user 120 has quiet hours of 8:30 PM to 5:00 AM on Sunday through Thursday, 11:00 PM to 9:00 AM on Friday through Saturday, and 10:00 PM to 7:00 AM on Saturday through Sunday. Thus, the digital assistant 206 may automatically enable the quiet time mode 210 within the learned quiet time hours 208 and disable the quiet time mode 210 outside of the learned quiet time hours 208.

Notably, the learned quiet time hours 208 are not the same for each day. In addition, the quiet time hours 208 may be non-contiguous time periods. For example, the user 120 may not want quiet time mode 210 to be enabled on Saturdays. Thus, the quiet time hours 208 that are learned may be for time periods from Sunday through Friday and skipping Saturday.

In another example, the secondary devices 112 and 114 may be smart thermostats. For example, the digital assistant 206 may learn that the secondary device 114 located downstairs at the location 150 is scheduled to turn down the heat in the winter time around 8:00 PM and turn back on around 5:00 AM. The digital assistant 206 may also learn that the secondary device 112 located upstairs is scheduled to turn up the heat around 8:00 PM and turn down the heat around 5:00 AM.

As a result, the digital assistant 206 may learn a pattern of behavior of how the thermostats of the secondary devices 112 and 114 are adjusted. Based on the above information, the digital assistant 206 may learn that the user goes to bed around 8:00 PM and wakes up around 5:00 AM. Thus, the digital assistant 206 may learn the quiet time hours 208 of 8:00 PM to 5:00 AM and enable the quiet time mode 210 during the quiet time hours 208 that are learned.

In another example, the secondary device 116 may be smart power switch that is labeled “bedroom light.” For example, the digital assistant 206 may learn that the secondary device 116 is turned on around 8:00 PM, but then turned off around 10:00 PM. Thus, the digital assistant 206 may learn a pattern of behavior of when the user 120 goes to sleep.

The digital assistant 206 may use information from a combination of different secondary devices 110, 112, 114, 116, and 118 to learn the quiet time hours 208. For example, using the secondary device 116, the digital assistant 206 may learn when the user 120 goes to sleep, but may not know when the user wakes up. However, based on data from the secondary devices 110, 112, and 114, the digital assistant 206 may learn when the user wakes up and learn the quiet time hours 208 accordingly. The digital assistant 206 may then enable or disable the quiet time mode 210 accordingly.

In one example, patterns of behavior other than sleep may be learned. The other patterns of behavior may include a personal activity (e.g., an appointment, watching a movie, having family time, having guests over, and the like). For example, the secondary device 118 may be a computer that executes a calendar application. The user 120 may store details of appointments in the calendar application. The digital assistant 206 may obtain calendar information from the secondary device 118 and learn the quiet time hours based on when the user 120 has appointments. In one example, the user 120 may enable a quiet time mode request in an appointment on the calendar application. When, the digital assistant 206 receives the appointment information from the secondary device 118, the digital assistant 206 may know which appointments will use the quiet time mode 210.

In other examples, the digital assistant 206 may learn the quiet time hours 208 based on real-time data that is periodically transmitted by the secondary devices 110, 112, 114, 116, and 118. For example, the secondary device 110 may be a wearable device that collects heart rate data. The digital assistant 206 may learn that the user 120 goes to sleep at certain times of the day based on the heart rate data (e.g., the heart rate may have a lower average when the user 120 is sleeping compared to when the user 120 is awake). The digital assistant 206 may then learn the quiet time hours 208 based on the real-time data that is collected and analyzed.

The secondary devices 110, 112, 114, 116, and 118 are provided as examples. Other secondary devices may also be deployed such as smart lights, smart televisions, and the like. Some smart devices 110, 112, 114, 116, and 118 may allow the digital assistant 206 to learn the quiet time hours 208 on the fly. For example, the digital assistant 206 may detect that smart lights in the living room are turned down or turned off and that the smart television is turned on. The digital assistant 206 may determine that the user 120 is watching a movie and enable the quiet time mode 210 automatically.

By monitoring the activity of the user 120 to learn a pattern of behavior, the digital assistant 206 may automatically learn the quiet time hours 208. Based on the quiet time hours 208 that are learned, the digital assistant 206 may automatically enable or disable the quiet time mode 210.

Thus, the voice activated device 102 may prevent any notifications that are received from being played to the user, being audible, or being seen when the quiet time mode 210 is enabled. In other words, any notifications that may be received from third party applications being executed on the voice activated device 102, or being played as part of a power up/down cycle may be suppressed.

The third party applications may be skills or applications that are executed by the voice activated device 102. For example, the notifications may include news updates, sports scores, daily task lists, incoming phone calls via the voice activated device 102, and the like. Some notifications may be provided in the middle of the night when the third party applications are being updated. As noted above, during the quiet time hours 208 that are learned the notifications may be disruptive to the user 120 who may be sleeping, on a telephone call appointment, watching a movie, and the like. Thus, enabling the quiet time mode 210 may allow these notifications to be suppressed.

In one example, the quiet time mode 210 may be stored in a part of the computer readable medium 106 that also stores the operating system of the voice activated device 102. As a result, the first operation that is checked when a power up cycle or a power down cycle is detected is whether the quiet time mode 210 is enabled. As a result, if the quiet time mode 210 is enabled, no visual or audio notification may be emitted by the voice activated device 102.

For example, the voice activated device 102 may provide an audible notification such as “hello” or “goodbye” when powering up or down, respectively. The voice activated device 102 may also emit a light or animate a light ring to provide a visual indication that the voice activated device 102 is activating or powering up. In the middle of the night a power outage may occur. When the power comes back on, the voice activated device 102 may power back on and generate the audible notification or the visual indication.

However, in one example, the quiet time mode 210 may be stored in the same computer readable medium 106 as the operating system. As a result, the first thing that is checked may be whether the quiet time mode 210 is enabled. If the quiet time mode 210 is enabled, the audible notifications and/or the visual indications that are normally produced during the power up cycle may be suppressed so that the user 120 is not awakened in the middle of the night when sleeping.

In one example, notifications may also be received for firmware updates for the voice activated device 102. The digital assistant 206 may notify the user that a firmware update is available and ask the user if they would like to apply the firmware update, or notify the user that the firmware update was automatically applied. The firmware update may also cause a reboot to occur which may cause the audible notifications and/or visual indications associated with a power down cycle and a power up cycle. When the quiet time mode 210 is enabled, these types of notifications may also be suppressed.

In one example, when the quiet time mode 210 is enabled, any incoming notifications may be stored in the computer readable medium 106. As noted above, the voice activated device 102 may include stored notifications 212. For example, some notifications such as incoming phone calls, software update notifications, and the like can be stored in the stored notifications 212 for later playback when the quiet time mode 210 is disabled.

For example, the digital assistant 206 may detect that there is a stored notification in the stored notifications 212. The digital assistant 206 may periodically monitor the status of the quiet time mode 210. When the quiet time mode 210 is disabled (e.g., the current time is outside of the quiet time hours 208 that are learned), the digital assistant 206 may provide a visual indication or an audible indication that a new notification has been stored. In one example, the visual indication may be a blinking light, or a light of a particular color. The audible indication may be a constant beeping or tone emitted by the speaker 202, having the digital assistant 206 state “you have a stored notification,” and the like. The user may provide a command to the digital assistant 206, such as “play my stored notifications” and the digital assistant 206 may play the notifications from the stored notifications 212.

In one example, the location 150 may include a plurality of voice activated devices 102. For example a voice activated device 102 may be located on each floor, in each room, and the like. The voice activated devices 102 may be linked to the same local area network (LAN) or WiFi network within the location 150.

In one example, when the quiet time mode 210 is activated on one of the voice activated devices 102, the quiet time mode 210 may be automatically activated on remaining voice activated devices 102. For example, when the quiet time mode 210 is activated on a first voice activated device 102, the first voice activated device 102 may transmit a signal to the remaining voice activated devices 102. The signal may instruct, or cause, the remaining voice activated devices 102 to also enable the quiet time mode 210 stored in the each one of the remaining voice activated devices 102.

As a result, the user may not have to manually enable the quiet time mode 210 for each individual voice activated device 102 in the location 150. Rather, a master, or main, voice activated device 102 may learn the quiet time hours 208, enable the quiet time mode 210, and proliferate a signal to the other child voice activated devices 102 to enable the quiet time mode 210 on the respective child voice activated devices 102.

In one example, when the quiet time mode 210 is activated on one of the voice activated devices 102, the quiet time mode 210 may be selectively enabled or disabled on other voice activated devices. For example, the voice activated device 102 may collect data from the secondary devices 110, 112, 114, 116, and 118 that are associated with different rooms in the location 150 or with different users 120. As a result, the digital assistant 206 may detect that a baby is sleeping in one room as part of the quiet time hours 208, while a user is interacting with a voice activated device in another room. As a result, the digital assistant 206 may enable the quiet time mode 210 for the voice activated device 102 in the room where the baby is sleeping, while disabling the quiet time mode 210 in the other room where the user is interacting with another voice activated device 102. Thus, based on the quiet time hours 208 for a particular user 120 of multiple users 120 in a location 150, or quiet time hours 208 for a particular room, the digital assistant 206 may selectively enable or disable the quiet time mode 210 for different voice activated devices 102 in the location 150.

In one example, the digital assistant 206 may learn the quiet time hours 208 based on interaction with the user 120 without the secondary devices 110, 112, 114, 116, and 118. For example, the digital assistant 206 may learn a pattern based on a lack of interaction with the user 120. In other words, after a certain time (e.g., 10:00 PM), the user 120 may stop asking the voice activated device 102 questions or stop providing commands to the voice activated device 102. The user 120 may then start providing commands or asking questions to the voice activated device 102 at another time (e.g., 6:00 AM). The digital assistant 206 may recognize a pattern (e.g., between 10:00 PM to 6:00 AM) Monday-Friday. The digital assistant 206 may then learn the quiet time hours 208 based on this pattern of interaction with the user 120 and enable the quiet time mode 210 during the learned quiet time hours 208.

It should be noted that the above examples describe examples of automatically enabling the quiet time mode 210. However, it should be noted that the voice activated device 102 may automatically disable the quiet time mode 210 as well. For example, when the digital assistant 206 detects that the current time is outside of the learned quiet time hours 208, the quiet time mode 210 may be automatically disabled.

Thus, the present disclosure enables a quiet time mode based on learned quiet time hours. As discussed above, the quiet time hours can be learned by learning a pattern of behavior based off of data collected from secondary devices in a location such as an activity monitor, a sleep monitor, a smart thermostat, a smart outlet, a smart light, a smart television, and the like.

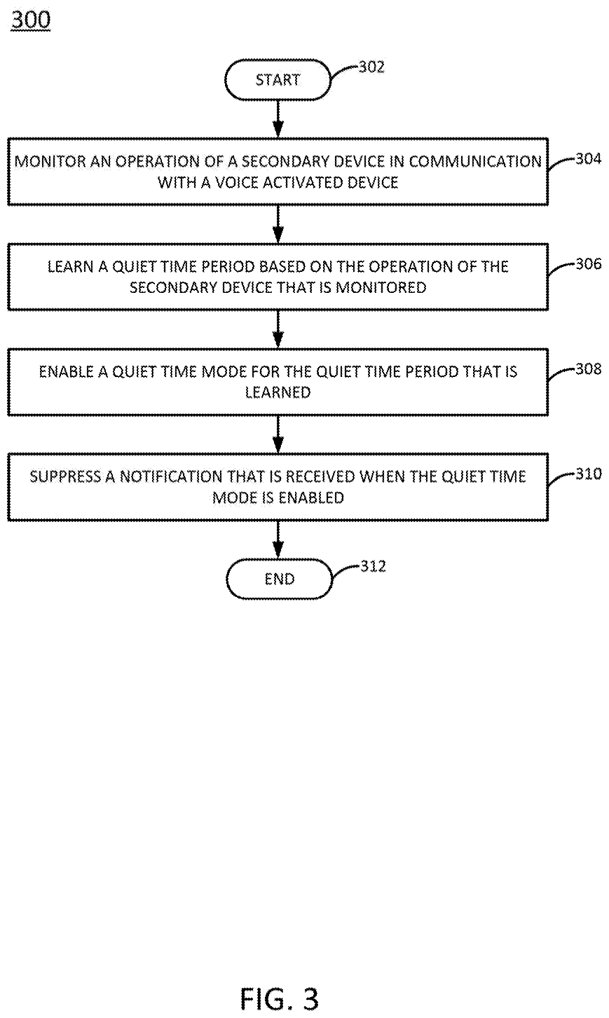

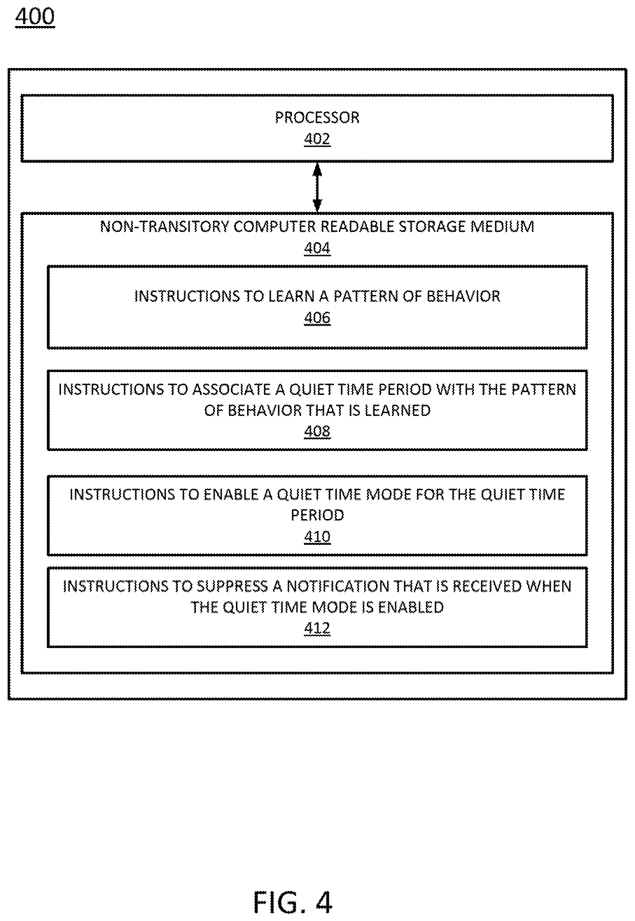

FIG. 3 illustrates a flow diagram of an example method 300 for learning a quiet time period to enable a quiet time mode. In one example, the method 300 may be performed by the apparatus 100 or the apparatus 400 illustrated in FIG. 4 and described below.

At block 302, the method 300 begins. At block 304, the method 300 monitors an operation of a secondary device in communication with a voice activated device. For example, at least one secondary device may establish a wireless communication path with the voice activated device, or vice versa. The secondary device may provide data such as when a user is sleeping, what temperature is set at what time, when a light is turned on or off, appointment times for a particular day, and the like.

The voice activated device may be a device that runs a digital assistant. The voice activated device may not have a graphical user interface. Rather, the digital assistant may provide a voice interface or speaking interface that allows the user to interact with the voice activated device via voice commands. The voice activated device may have speakers to provide an audible notification, or lights to provide a visual indication.

At block 306, the method 300 learns a quiet time period based on the operation of the secondary device that is monitored. For example, based on the data that is collected from the secondary device, the digital assistant may learn a pattern of behavior. The quiet time period may be learned based on the pattern of behavior. For example, if a user sleeps daily at 9:00 PM and wakes up at 7:00 AM, the quiet time period may be learned to be 9:00 PM to 7:00 AM daily. In another example, if the user has a conference call from 3:00 PM to 4:00 PM, the quiet time period may be learned to be 3:00 PM to 4:00 PM. Other examples of how the quiet time period are learned are described above with reference to FIGS. 1 and 2.

In some examples, the quiet time period may be non-contiguous time periods. For example, the quiet time period may be learned to be different on each day, may include weekdays, may include a particular pattern of behavior for certain days of the week, and the like.

At block 308, the method 300 enables a quiet time mode for the quiet time period that is learned. For example, after the quiet time period is learned, when the voice activated device detects a current time (e.g., via an internal clock) the digital assistant can automatically enable the quiet time mode.

At block 310, the method 300 suppresses a notification that is received when the quiet time mode is enabled. For example, when the quiet time mode is enabled, any notifications may be suppressed. The notifications may be from third party applications. The notifications may include a message indicating that an update was completed, an incoming voice call via the voice activated device, a daily news briefing, notifications to changes to smart devices connected to the voice activated device, and so forth.

In one example, the notifications may include audible notifications or visual indications during a power up and power down cycle. For example, if a power loss occurs and the power is turned back on in the middle of the night, then the voice activated device may suppress any lights or audible notifications indicating that the voice activated device is powering on.

In one example, some notifications can be stored for later playback or retrieval. For example, messages or incoming voice calls can be stored in memory. The digital assistant may periodically check to see if the quiet time mode is enabled. When the quiet time mode is disabled, the digital assistant may enable a visual indication or an audible indication so that the user knows a new notification has been stored. For example, a light of the voice activated device may blink or light up in a certain color. In another example, the digital assistant may notify the user via an audible indication when the user interacts with the digital assistant. At block 312, the method 300 ends.

FIG. 4 illustrates an example of an apparatus 400. In one example, the apparatus 400 may be the apparatus 100. In one example, the apparatus 400 may include a processor 402 and a non-transitory computer readable storage medium 404. The non-transitory computer readable storage medium 404 may include instructions 406, 408, 410 and 412 that, when executed by the processor 402, cause the processor 402 to perform various functions.

In one example, the instructions 406 may include instructions to learn a pattern of behavior. The instructions 408 may include instructions to associate a quiet time period with the pattern of behavior that is learned. The instructions 410 may include instructions to enable a quiet time mode for the quiet time period. The instructions 412 may include instructions to suppress a notification that is received when the quiet time mode is enabled.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method, comprising:
monitoring, by a processor of a voice activated device that is executing a digital assistant, an operation of a secondary device in communication with the voice activated device;
learning, by the processor, a quiet time period based on the operation of the secondary device that is monitored;
enabling, by the processor, a quiet time mode for the quiet time period that is learned; and
suppressing, by the processor, a notification that is received when the quiet time mode is enabled.

2. The method of claim 1, wherein the secondary device comprises a sleep tracking device and the monitoring the operation comprises collecting data of when a user goes to sleep and when a user wakes up.

3. The method of claim 1, wherein the secondary device comprises a smart thermostat and the monitoring the operation comprises collecting data of different temperatures set at different times.

4. The method of claim 1, wherein the secondary device comprises a smart outlet connected to a light source and the monitoring the operation comprises collecting data of when the light source is turned on and is turned off.

5. The method of claim 1, wherein the secondary device comprises a computing device with a calendar application and the monitoring the operation comprises tracking appointments in the calendar application.

6. The method of claim 1, wherein the suppressing comprises:
storing, by the processor, the notification in a memory of the voice activated device.

7. The method of claim 6, further comprising:
periodically checking, by the processor, whether the quiet time mode is disabled; and
activating, by the processor, a visual indication that the notification is stored in the memory when the quiet time mode is disabled.

8. A non-transitory computer readable storage medium encoded with instructions executable by a processor of a voice activated device executing a digital assistant, the non-transitory computer-readable storage medium comprising:
instructions to learn a pattern of behavior;
instructions to associate a quiet time period with the pattern of behavior that is learned;
instructions to enable a quiet time mode for the quiet time period; and
instructions to suppress a notification that is received when the quiet time mode is enabled.

9. The non-transitory computer readable storage medium of claim 8, further comprising:
instructions to transmit a signal to other voice activated devices within a local network that includes the voice activated device to enable the quiet time mode on the other voice activated devices.

10. The non-transitory computer readable storage medium of claim 8, wherein the quiet time period comprises non-contiguous time periods.

11. The non-transitory computer readable storage medium of claim 10, wherein the pattern of behavior is learned based on interaction with a user or data received from a secondary device.

12. The non-transitory computer readable storage medium of claim 10, wherein the notification is from a third party application and the instructions to suppress the notification comprise instructions to store the notification in a memory of the voice activated device.

13. An apparatus, comprising:
a wireless interface to communicate with a secondary device and collect operational data of the secondary device.
a computer readable medium to store instructions to execute a digital assistant and store a setting for a quiet time mode; and
a processor communicatively coupled to the wireless interface and the computer readable medium, wherein the processor is to learn a quiet time period based on the operational data that is collected, is to enable the quiet time mode based on the quiet time period, and is to suppress a notification that is received when the quiet time mode is enabled.

14. The apparatus of claim 13, further comprising:
a visual indicator to provide a visual indication during a power on cycle, wherein the processor is to suppress the visual indication during the power on cycle when the quiet time period is enabled.

15. The apparatus of claim 14, further comprising:
a speaker to provide an audio notification during a power on cycle, wherein the processor is to suppress the audio notification during the power on cycle when the quiet time period is enabled.
